(19) United States
(12) Patent Application Publication
(10) Pub. No.: US 2007/0244686 A1
(43) Pub. Date: Oct. 18, 2007

(54) Calibration method for mixed-mode simulation

(75) Inventors: Yaong-Jar Chang, Taichung County (TW); Yung-Chieh Lin, I-Lan County (TW); Jung-Chi Ho, Taipei County (TW); Pei-Wen Luo, Kaohsiung County (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/481,846

(22) Filed: Jul. 7, 2006

(30) Foreign Application Priority Data
Apr. 13, 2006 (TW) 95113144

(51) Int. Cl. G06F 17/50

(52) U.S. Cl. 703/19

(57) ABSTRACT

A calibration method of a mixed mode simulation calibrates standard delay times in a standard delay format and includes obtaining a digital output circuit from a digital circuit, obtaining an analog output circuit from an analog circuit, performing a simulation on the digital output circuit connected to the analog output circuit to obtain an ideal output, obtaining a first delay time according to the standard delay times of the digital output circuit, performing a calibrative analog-to-digital mixed mode simulation using the first delay time to obtain an analog-to-digital mixed output, comparing the ideal output and the analog-to-digital mixed output to calibrate the first delay time, and calibrating the standard delay times of the digital output circuit according to the calibrated first delay time.

### BACKGROUND OF THE INVENTION

1. Field of the Invention

The invention relates to mixed-mode simulation, and in particular to a calibration method for mixed-mode simulation.

2. Description of the Related Art

Integration of analog and digital circuits into a single chip not only enhances overall performance of the chip but also reduces power consumption, chip area, and production costs.

As analog/mixed-signal designs become increasingly complicated, ordinary simulation tools such as SPICE and Fast SPICE cannot meet current simulation requirements such as simulation speed and design capacity in system on a chip (SOC). Electronic Design Automation (EDA) has thus developed a simulation environment for co-operation of digital simulator (such as VERILOG) and analog simulator (such as SPICE), referred to as mixed-mode simulation, for the purpose of solving currently encountered difficulties.

FIG. 1 is a flowchart of a conventional mixed-signal design. The system to be simulated is separated into digital and analog circuits. As shown, during a mixed-signal design, digital and analog circuit designs undergo independent process, as shown by flowcharts respectively in blocks 11 and 12 on the left and right sides of the figure. As shown, in digital design (in step 11), resistor transfer level (RTL) design is initially realized using digital simulators such as VERILOG (in step 13), and logic synthesis is sequentially carried out to convert RTL design to gate level design and obtain gate netlist (in step 14). In step 14, static timing analysis (STA) is performed, and timing information obtained thereby is registered as standard delay format DATA-SDF.

In analog design, behavior mode design is first realized using high level analog behavior simulator (in step 15), and then the behavior mode design is converted to circuit design (in step 16). After that, the whole gate-level layout is obtained using tools such as SPICE to perform transistor level simulation (in step 17). Next, the process enters an integration stage of place and route layout (in step 19). Because physical circuits have extra parasitic resistance and capacitance, STA is further performed on the digital circuit to obtain time information for standard delay format DATA-SDF. Additionally, parasitic resistance/capacitance extraction is performed on the analog circuit to obtain resistance/capacitance data DATA-RC more suitable for realistic design.

During the overall design process, a mixed-mode simulation can be performed for parallel connection of the digital design with the analog designs to verify whether the system behavior is correct and whether the system performance meets predetermined requirements (in step 18). Major suppliers for EDA software, for example, CADENCE or SYNOPSYS, all provide mixed-mode simulators. In recent years, Soc Technology Center of the Industrial Technology Research Institute in Taiwan has cooperated with National Central University in Taiwan to develop new technology referred to as ACADEMIC improving the accuracy of Mixed-mode simulators.

FIG. 2A is a block diagram of a mixed-mode simulator. FIG. 2B is a schematic diagram used in a mixed-mode simulation performed by the mixed-mode simulator of FIG. 2A. Referring to FIG. 2A, a mixed-mode simulator 20 comprises a digital simulator 21 (such as VERILOG), an interface signal converter 22 and an analog simulator 23 (such as SPICE). The mixed-mode simulator 20 receives digital design data DATA-DIGITAL, analog design data DATA-ANALOG, and timing information of the digital circuit represented by standard delay format DATA-SDF. Referring back to FIG. 1, the digital design data can be RTL design data obtained in step 13, or netlest data DATA-NETLIST obtained by step 14. The analog design data DATA-ANALOG can be behavior-model design data DTAT-BEHAVIOR obtained by step 15, or circuit design data obtained by step 16, or layout data DATA-LAYOUT obtained by step 16. Additionally, after step 19 is completed, the analog design data DATA-ANALOG is modified based on resistance/capacitance data DATA-RC.

Referring to FIGS. 2A and 2B, digital simulator 21 performs simulations on a digital circuit 24 represented by the digital design data DATA-DIGITAL according to timing information represented by the stand delay format DATA-SDF of the digital circuit 24, and outputs calculation result as a digital output DOUT representing transition events of a digital output signal SDOUT, the timing of which is determined by delay time of each stage in the digital circuit 24 recoded by the standard delay format DATA-SDF.

Similarly, analog simulator 23 performs simulations on an analog circuit 26 represented by the analog design data DATA-ANALOG and outputs calculation result as an analog output AOUT representing continuous voltage values of an analog output signal SAOUT.

The interface signal converter 22 acts as a communication agent for the digital simulator 21 and analog simulator 23, converting the digital output DOUT and analog output AOUT bi-directionally. When the calculation result of the digital simulator 21 is to be transmitted to the analog simulator 23, the interface signal converter 22 converts the digital output DOUT to a digital-to-analog mixed output MIXD2A according to element data about a digital-to-analog interface element, and then transmits the digital-to-analog mixed output MIXD2A to the analog simulator 23. Referring to FIG. 2B, an interface element 25 (now acting as a digital-to-analog interface element) converts the digital output signal SDOUT to a digital-to-analog mixed signal SMIXD2A corresponding to the digital-to-analog mixed output MIXD2A in FIG. 2A. Conversely, when the calculation result of the analog simulator 23 is to be transmitted to the digital simulator 21, the interface signal converter 22 converts the analog output AOUT to an analog-to-digital mixed output MIXA2D according to element data about an analog-to-digital interface element, and then transmits the analog-to-digital mixed output MIXA2D to the digital simulator 21. Referring to FIG. 2B, the interface element 25 (now acting as an analog-to-digital interface element) converts the analog output signal SAOUT to an analog-to-digital mixed signal SMIXA2D corresponding to the analog-to-digital mixed output MIXA2D in FIG. 2A.

Different mixed-mode simulators have different interface elements and setting methods thereof. For example, CADENCE provides several parametrizable interface element models for selection. In addition, CADENCE supports VERILOG-AMS language such that customized interface elements can be designed. SYNOPSYS sets interface elements using resistance map. ACADEMIC provides resistance and capacitance models and parameter setting rules thereof.

FIG. 3 is a timing diagram of digital output signal SDOUT and digital-to-analog mixed signal SMIXD2A of FIG. 2B. FIG. 3 also shows realistic output signal of the digital circuit 24 when the digital circuit 24 and analog circuit 25 are connected and co-simulated. It is noted that, FIG. 3 is illustrated shows the digital output signal SDOUT moving from low to high, with the inverse readily deduced.

In the figure, time difference between dashed lines L1 and L2 is denoted by delay time SDF. As described, the delay time SDF is generated according to standard delay time for each stage of the digital circuit 24 recorded by the standard delay format DATA-SDF.

The curve of the digital-to-analog mixed signal SMIXD2A moving from low to high or high to low is referred to as a transition curve. Dependent on different digital-to-analog interface element, the digital-to-analog mixed signal SMIXD2A has different transition curves. As shown, the transition curve of the digital-to-analog mixed signal SMIXD2A generated by a digital-to-analog interface element in a mixed-mode simulator resemble the transition curve of the realistic output signal SREAL in reality.

As shown, time difference T_{MIX} between the dashed line L1 and the arrival of the digital-to-analog mixed signal SMIXD2A at VDD/2, compared to time difference T_{REAL} between the dashed line L1 and the arrival of the realistic output signal SREAL at VDD/2, is longer by an extra delay time ED. That is, a problem in conventional mixed-mode simulation is that the digital-to-analog mixed signal SMIXD2A falls behind the realistic output signal SREAL.

Conventional mixed-mode simulation software, CADENCE, SYNOPSYS, or ACADEMIC, all considers only the shape of the transition curve but ignores the problem of the extra delay time ED, resulting in lower simulation accuracy. However, as the design process proceeds close to the back end, accuracy is much more important. Accordingly, calibration of the standard delay times recorded by the standard delay format DATA-SDF to approximate time difference T_{MIX} to time difference T_{REAL} thereby minimizing the extra delay time ED is necessary.

### BRIEF SUMMARY OF THE INVENTION

Accordingly, the invention discloses a calibration method for mixed-mode simulation to calibrate standard delay times of a standard delay format and solve problems induced by extra delay time.

The invention provides a calibration method for a mixed-mode simulation for calibrating standard delay times in a standard delay format, comprising: selecting a partial circuit at the output end in a digital circuit on which the mixed-mode simulation is to be performed as a digital output circuit, selecting a partial circuit at the input end in an analog circuit on which the mixed-mode simulation is to be performed as an analog input circuit, performing a simulation on the digital output circuit connected with the analog input circuit using a transistor level simulator such as SPICE or a gate level simulator such as VERILOG along with static timing analysis and obtaining an ideal output, obtaining an initial value of a first delay time according to the standard delay times of the digital circuit recorded in the standard delay format, performing a calibrative digital-to-analog mixed mode simulation on the digital output circuit and the analog input circuit to obtain a digital-to-analog mixed output using the first delay time at least once, every time after the calibrative digital-to-analog mixed mode simulation is performed, obtaining an extra delay time by comparing the digital-to-analog mixed output with the ideal output and sequentially calibrating the first delay time according to the extra delay time using a predetermined calibration method such as direct subtraction method or interpolation/extrapolation method, and calibrating the standard delay times of the digital output circuit in the standard delay format according to the final calibrated value of the first delay time.

In an embodiment, the calibrative digital-to-analog mixed mode simulation is performed a predetermined number of times. In another embodiment, the calibrative digital-to-analog mixed mode simulation is performed until the extra delay time is shorter than a predetermined extra delay time.

Embodiments of the invention improve the accuracy of the mixed mode simulation, thereby preventing false design, and non-convergence problems occurring in many mixed-mode simulations can be prevented.

Further, separation of the digital and analog circuits has higher flexibility.

Further, the calibration method is not restricted by mixed-mode simulation software.

Further, circuit area to be simulated can be selected very small, and simulation speed increases accordingly.

### BRIEF DESCRIPTION OF THE DRAWINGS

The invention can be more fully understood by reading the subsequent detailed description and examples with references made to the accompanying drawings, wherein:

FIG. 1 is a flowchart of a conventional mixed-signal design;

FIGS. 2A and 2B are respectively a block diagram of a mixed-mode simulator and a schematic diagram used in a mixed-mode simulation performed by the mixed-mode simulator of FIG. 2A;

FIG. 3 is a timing diagram of digital output signal and digital-to-analog mixed signal of FIG. 2B;

FIG. 4 is a flowchart of a mixed-signal design provided in the invention;

FIG. 5 is a flowchart of a calibration method for mixed-mode simulation in accordance with an embodiment of the invention;

FIG. 6 is a timing diagram of digital output signal, digital-to-analog mixed signal, and ideal output signal;

FIGS. 7A and 7B are respectively a schematic diagram of steps 520 and 530 in accordance with an embodiment of the invention and a schematic diagram of a calibrative digital-to-analog mixed mode simulation of FIG. 7A;

FIG. 7C is a schematic diagram of a digital-to-analog interface element in accordance with an embodiment of the invention;

FIG. 8 is a flowchart of an embodiment in which a calibrative digital-to-analog mixed mode simulation is performed a predetermined number of times.

FIG. 9 is a flowchart of an embodiment in which a calibrative digital-to-analog mixed mode simulation is performed until extra delay time is shorter than a predetermined extra delay time;

FIG. 10 is a flowchart of a calibration method for mixed-mode simulation in FIG. 8 when the predetermined number is 2;

FIG. 11 shows proper range of capacitance value corresponding to different buffers in FIGS. 7A-7C using the method of FIG. 10; and

FIG. 12 shows delay times of digital-to-analog mixed signals obtained by simulations with different mixed-mode simulators and calibrated using the calibration method of the invention, for every corner case of FIG. 11.

### DETAILED DESCRIPTION OF THE INVENTION

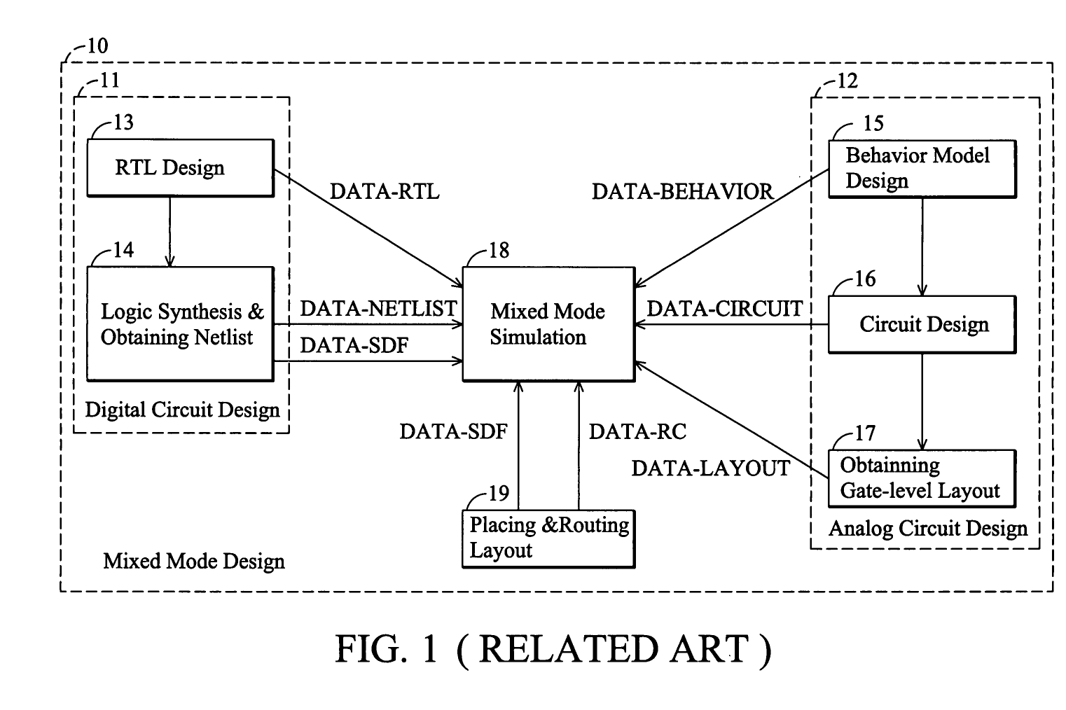

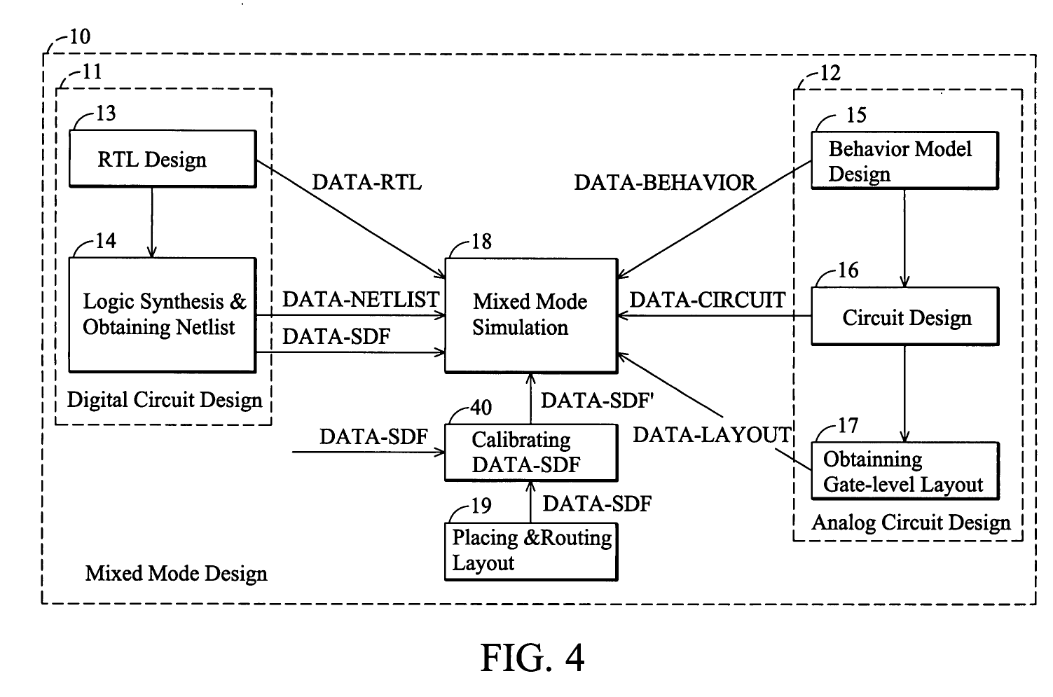

FIG. 4 is a flowchart of a mixed-signal design provided in the invention, differing from that of FIG. 1 only in that standard delay format DATA-SDF generated in step 14 is not provided directly to a mixed-mode simulator. Rather, it is calibrated to DATA-SDF′ in step 40 before being provided to the mixed-mode simulator. In addition, standard delay format DATA-SDF generated in step 19 can also be calibrated to DATA-SDF′ in step 40 before provided to the mixed-mode simulator.

The following describes in detail calibration for mixed-mode simulation used in step 40.

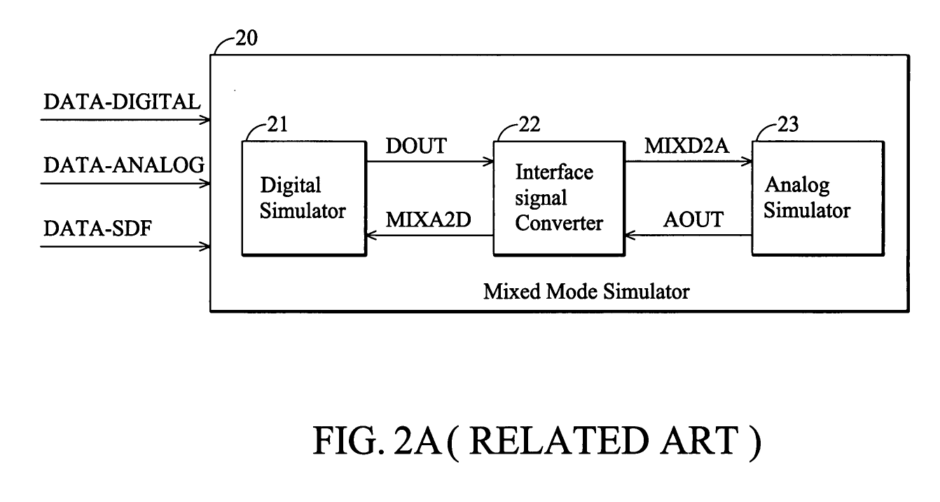

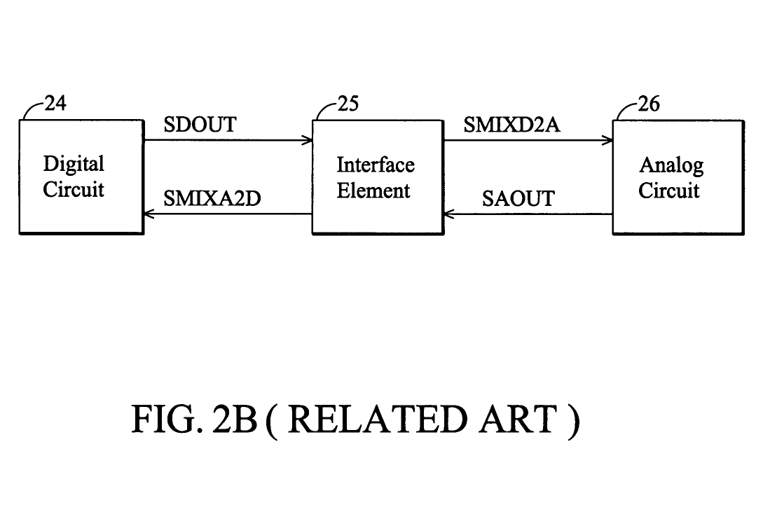

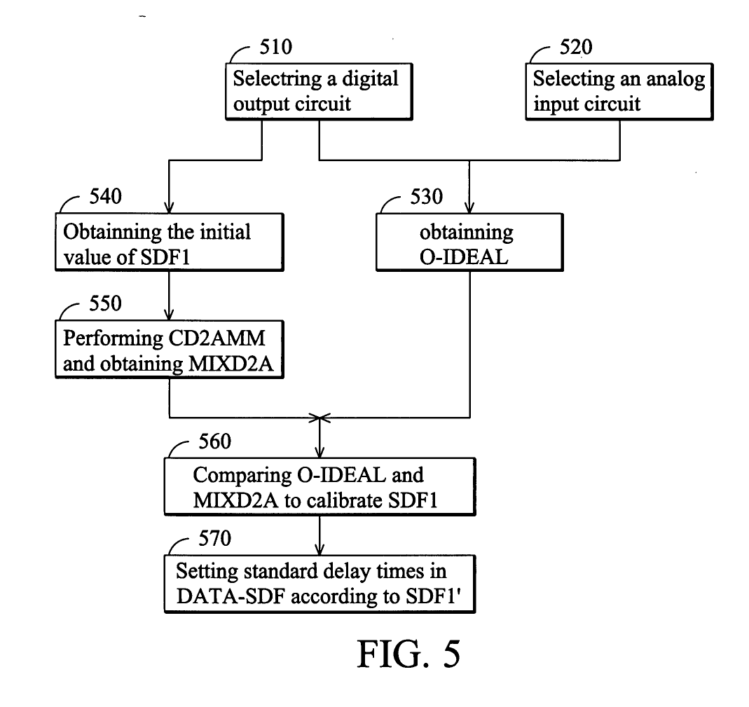

FIG. 5 is a flowchart of a calibration method for mixed-mode simulation in accordance with an embodiment of the invention. As shown, in step 510, a partial circuit at the output end in a digital circuit on which the mixed-mode simulation is to be performed (digital circuit 24 in FIG. 2) is selected as a digital output circuit. In step 520, a partial circuit at the input end in an analog circuit on which the mixed-mode simulation is to be performed (analog circuit 26 in FIG. 2) is selected as an analog input circuit. In an embodiment, the digital output circuit is selected as the logic components at the last stage of the digital circuit, and the analog input circuit is selected as an input capacitor of the analog circuit.

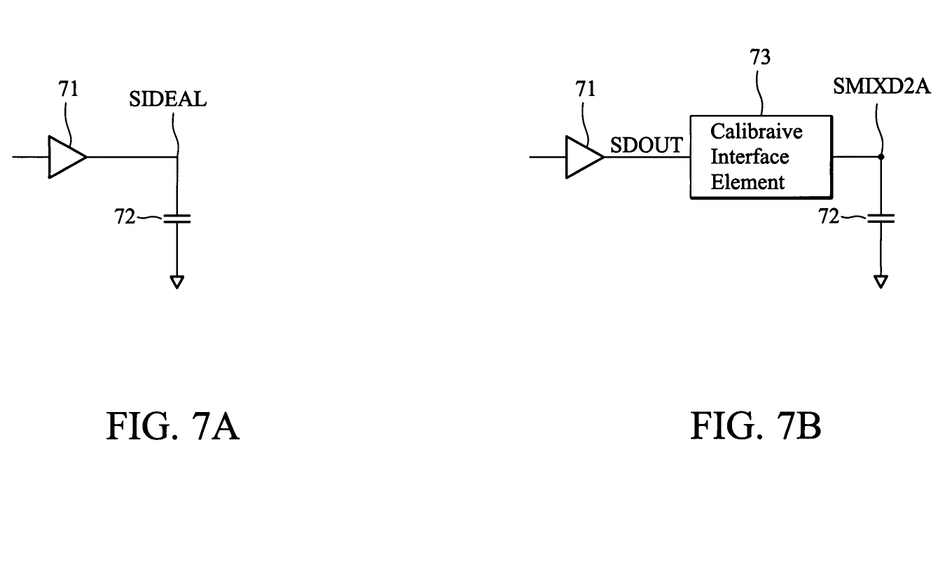

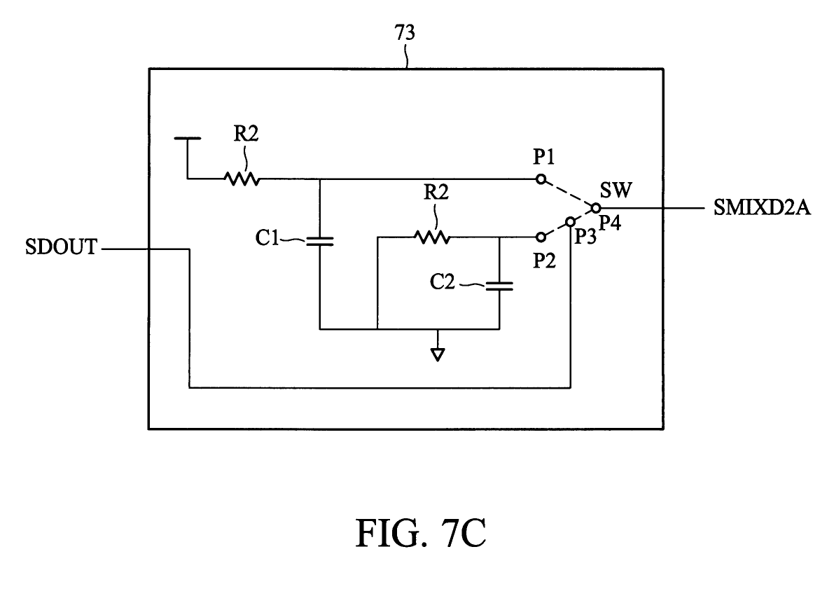

In step 530, a simulation is performed on the digital output circuit connected with the analog input circuit using a transistor level simulator such as SPICE or a gate level simulator such as VERILOG along with static timing analysis, and an ideal output O-IDEAL is obtained. FIG. 7A is a schematic diagram used in the steps 520 and 530 in an embodiment. As shown, a buffer 71 at the last stage of a digital circuit is selected as a digital output circuit, an input capacitor 72 of an analog circuit is selected as an analog input circuit, and an ideal output signal SIDEAL corresponds to an ideal output O-IDEAL.

In step 540, an initial value of a first delay time SDF, is obtained according to standard delay times of the digital output circuit. This is achieved by summing the standard delay times of all stages of the digital output circuit originally recorded by standard delay format DATA-SDF in FIG. 4.

In step 550, a calibrative digital-to-analog mixed mode simulation CD2AMM using the initial value of the first delay time is performed on the digital output circuit and the analog input circuit, and a digital-to-analog mixed output MIXD2A is obtained. The circuit used in the calibrative digital-to-analog mixed mode simulation CD2AMM can be as shown in FIG. 2, wherein the interface element 25 is now replaced by an calibrative digital-to-analog interface element, the digital circuit 24 is replaced by the digital output circuit, and the analog circuit 26 is replaced by the analog output circuit. The delay time of the digital output signal SDOUT is the initial value of the first delay time. The calibrative digital-to-analog interface element can be customized by users or the digital-to-analog interface element of the same mixed-mode simulator used in step 18 in FIG. 4.

FIG. 7B is a schematic diagram of the embodiment of the calibrative digital-to-analog mixed mode simulation of FIG. 7A, comprising a buffer 71, a capacitor 72 and a calibrative digital-to-analog interface element 73. Standard delay time of the buffer 71 recorded in the standard delay format DATA-SDF (i.e. the delay time of the digital output signal SDOUT) is thus the initial value SDF₁ of the first delay time SDF1. Digital-to-analog mixed signal SMIXD2A output by the calibrative digital-to-analog interface element 73 corresponds to the digital-to-analog mixed signal MLXD2A.

FIG. 7C is a schematic diagram of a digital-to-analog interface element in accordance with an embodiment of the invention. As shown, the digital-to-analog interface element comprises a selecting switch SW, first and second resistors R1 and R2, and first and second capacitors C1 and C2. The selecting switch SW has first to fourth terminals P1-P4. The first and second resistors R1 and R2 are respectively connected between a voltage source VDD and the first terminal P1, and between a reference voltage (for example, ground as shown) and the second terminal P2. The first and second capacitors C1 and C2 are respectively connected between the reference voltage and the first terminal P1, and between the reference voltage and the second terminal P2. The third terminal P3 receives the digital output signal SDOUT from the digital output circuit to direct the digital-to-analog mixed signal SMIXD2A at terminal P4 to output voltage at terminal P1 or P2.

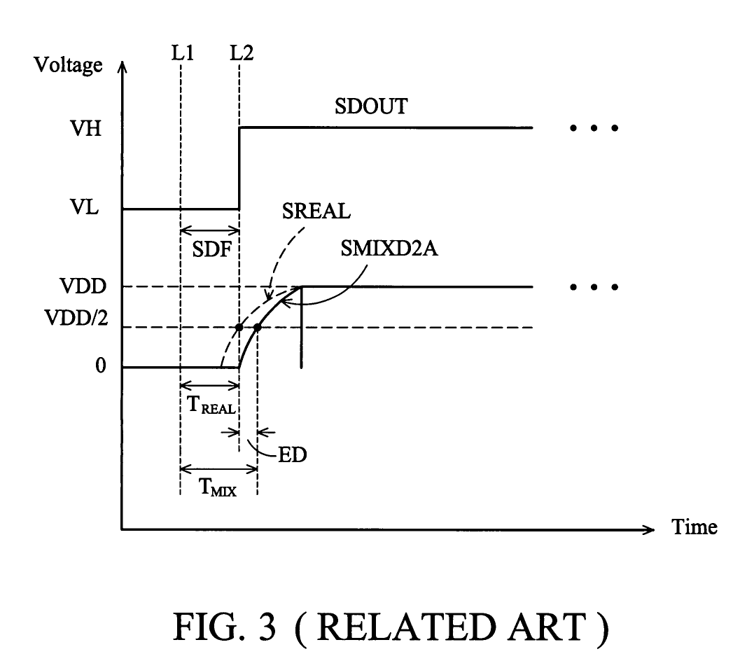

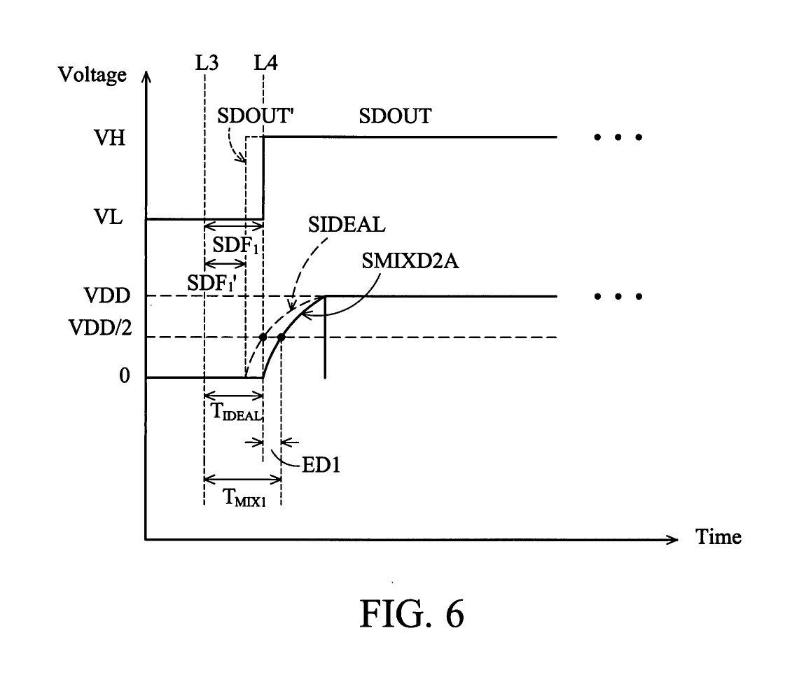

FIG. 6 is a timing diagram of the digital output signal SDOUT corresponding to the digital output DOUT, digital-to-analog mixed signal SMIXD2A corresponding to the digital-to-analog mixed output MIXD2A, and the ideal output signal SIDEAL corresponding to the ideal output O-IDEAL. As shown, delay times of the digital output signal SDOUT (calculated with the dashed line L4), digital-to-analog mixed signal MIXD2A (calculated with the time it reaches VDD/2), and ideal output signal SIDEAL (calculated with the time it reaches VDD/2), between the dashed line L3, are respectively SDF₁, T_{MIX1} and T_{IDEAL}. As described, the delay time SDF1 in the figure is the initial value of the first delay time SDF1. The calibration method for mixed-mode simulation provided in the invention calibrates the delay time SDF₁ to SDF₁′, that is, to calibrate the digital output signal SDOUT to SDOUT′, such that the extra delay time ED1 approximates zero. It is noted that as the area of the digital output circuit and analog input circuit selected respectively in the digital and analog circuits increases, the timing of the ideal output signal SIDEAL approaches that of the realistic output signal SREAL in FIG. 3, that is, the closer the delay time T_{IDEAL} gets to T_{MIX1}, and accordingly, the closer T_{MIX1} gets to T_{REAL}.

As shown in FIG. 5, in step 560, the digital-to-analog mixed output MIXD2A is compared to the ideal output O-IDEAL to calibrate the first delay time SDF1. Referring to FIG. 6, in an embodiment, in step 560, the delay time T_{MIX1} of the digital-to-analog mixed output signal SMIXD2A is compared to the delay time T_{IDEAL} of the ideal output signal SIDEAL and the time difference therebetween (i.e. the extra delay time ED1) is obtained. Next, the first delay time SDF1 is calibrated according to the extra delay time ED1 using a predetermined calibration method.

The predetermined calibration method, for example, can be direct subtraction method:

SDF′=SDF₁−ED1,

where SDF1′ denotes calibrated first delay time, SDF₁ denotes the initial value of the first delay time SDF, and ED1 denotes the extra delay time.

Finally, in step 570, the standard delay times of the digital output circuit recoded in the standard delay format DATA-SDF, i.e. the standard delay times of the digital output circuit of the calibrated standard delay format DATA-SDF′ shown in FIG. 4, are obtained according to the calibrated value SDF1′ of the first delay time SDF1. More specifically, the calibrated value SDF₁′ of the first delay time SDF1 is portioned into the standard delay time of each stage in the digital output circuit using a predetermined setting method. The predetermined setting method, for example, portions the calibrated value SDF₁′ according to the original proportions of the standard delay times of the stages in the digital output circuit. Alternatively, the predetermined setting method distributes the difference between SDF₁′ and SDF₁ (i.e. (SDF₁′-SDF₁)) equally to the standard delay times of the stages in the digital output circuit. If the logic component of last stage in the digital circuit is selected as the digital output circuit, the calibrated standard delay time of the logic component is set as the calibrated value SDF₁′ of the first delay time.

It is noted that the calibrative digital-to-analog mixed mode simulation CD2AMM can be performed more than once, with the first delay time calibrated according to the simulation result after every simulation.

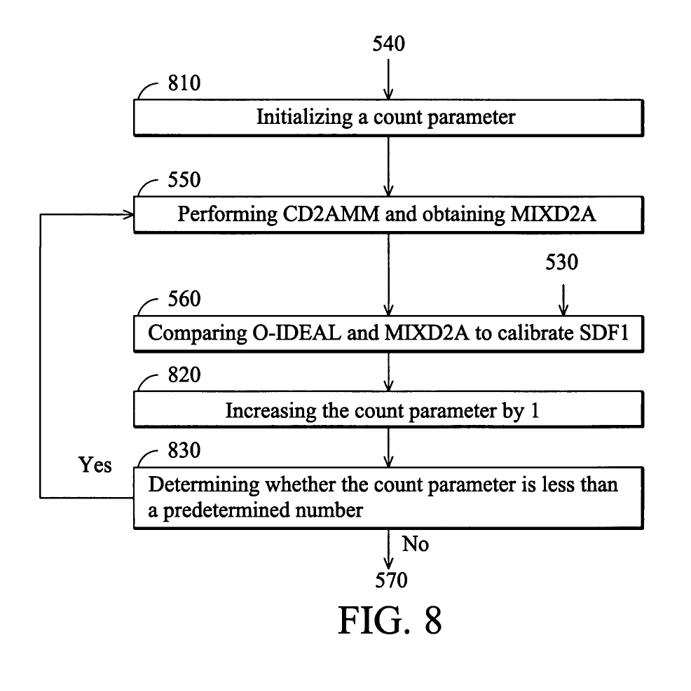

In an embodiment, the calibrative digital-to-analog mixed mode simulation is performed a predetermined number of times. FIG. 8 is a flowchart of the embodiment. First, before step 50, a count parameter is initialized to zero (in step 810). Steps 550 and 560 are sequentially performed. In step 820, the count parameter is increased by 1. Next, in step 830, it is determined whether the count parameter is less than a predetermined number. If so (“Yes”), the process returns to step 550. Otherwise, if not (“No”), step 570 is executed using the final calibrated value SDF′ of the first delay time SDF. It is noted that in step 550, if the calibrative digital-to-analog mixed mode simulation CD2AMM is performed for the first time, the initial value of the first delay time is used. After, each calibrative digital-to-analog mixed mode simulation CD2AMM is performed with the calibrated first delay time SDF′.

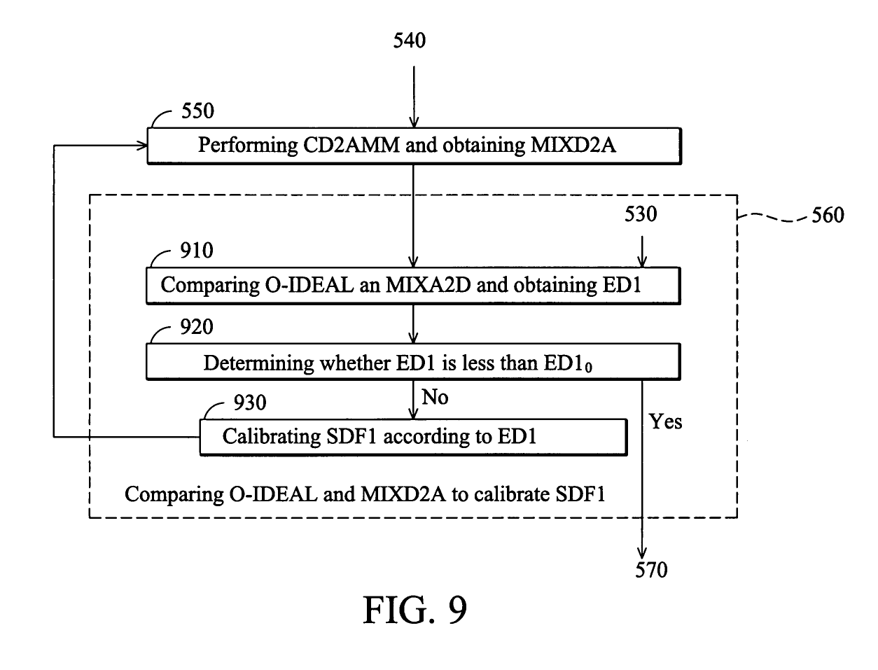

In another embodiment, the calibrative digital-to-analog mixed mode simulation CD2AMM is performed until the extra delay time is less than a predetermined extra delay time. FIG. 9 is a flowchart of the embodiment. As shown, step 560 comprises several sub-steps. Before step 560 is performed, step 90 is performed to obtain an extra delay time ED1 by comparing the real output O-IDEAL and the digital-to-analog mixed output MIXD2A. In step 920, it is determined whether the extra delay time is less than a predetermined extra delay time ED1₀. If not (“No”), step 930 calibrates the first delay time SDF1 according to the extra delay time ED1 using a predetermined calibration method and then return to step 550. Otherwise, if so, step 570 is performed using the final calibrated value SDF′ of the first delay time SDF. Similarly, it is noted that in step 550, if the calibrative digital-to-analog mixed mode simulation CD2AMM is performed for the first time, the initial value of the first delay time is used. After, each calibrative digital-to-analog mixed mode simulation CD2AMM is performed with the calibrated first delay time SDF′.

In FIGS. 8 and 9, when the calibrative digital-to-analog mixed mode simulation CD2AMM is not performed for the first time, the predetermined calibration method can be direct subtraction method or interpolation/extrapolation method. The direct subtraction method, as described, is:

SDF1(n+1)=SDF1(n)−ED(n),

where SDF1(n+1) denotes the calibrated first delay time after the current (the nth time of) calibrative digital-to-analog mixed mode simulation, SDF1(n) denotes the first delay time used in the current calibrative digital-to-analog mixed mode simulation, and ED1(n) denotes the extra delay time obtained by the current calibrative digital-to-analog mixed mode simulation.

The interpolation/extrapolation method comprises:

SDF1(n+1)=SDF1(n)−ED(n)×(SDF1(n)−SDF1(n−1))/(ED1(n)−ED(n−1)),

where SDF1(n+1) denotes the calibrated first delay time after the current (the nth time of) calibrative digital-to-analog mixed mode simulation, SDF1(n) denotes the first delay time used in the current calibrative digital-to-analog mixed mode simulation, SDF1(n−1) denotes the first delay time used in the previous calibrative digital-to-analog mixed mode simulation, ED1(n) denotes the extra delay time obtained by the current calibrative digital-to-analog mixed mode simulation, and ED1(n−1) denotes the extra delay time obtained by the previous calibrative digital-to-analog mixed mode simulation.

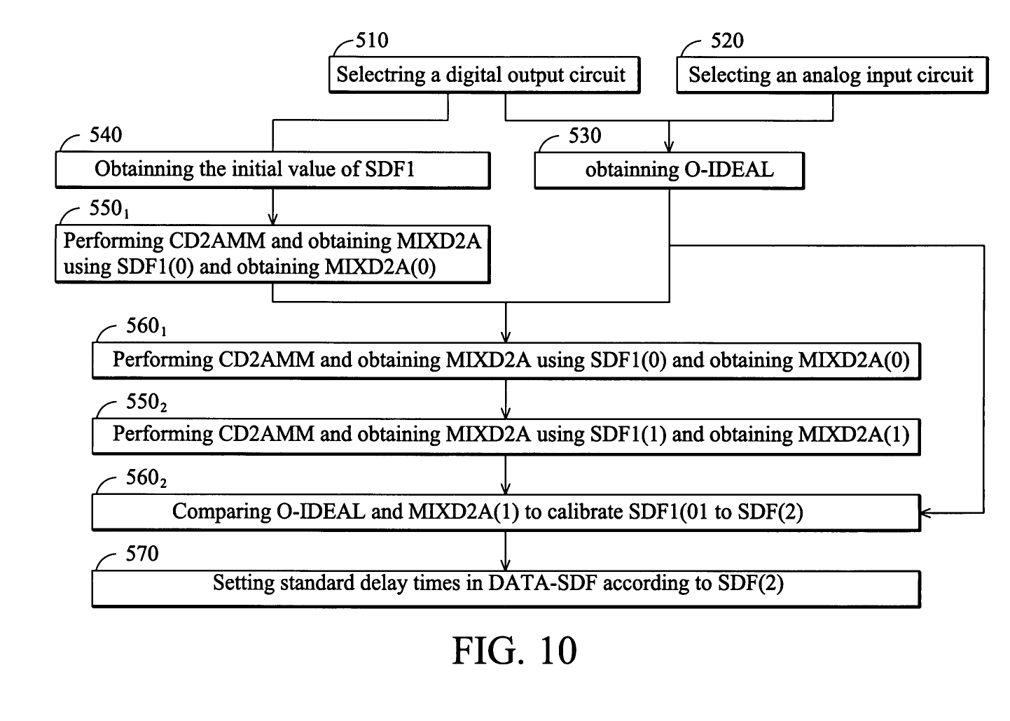

FIG. 10 is a flowchart of a calibration method for mixed-mode simulation in FIG. 8 when the predetermined number is 2. First, in step 550₁, the first CD2AMM is executed using the initial value SDF1(0) of the first delay time SDF1, and an initial digital-to-analog mixed output MIXD2A(0) is obtained. In step 560₁, the ideal output O-IDEAL obtained in step 530 is compared with the initial digital-to-analog mixed output MIXD2A(0), and SDF1(0) is modified to the first calibrated value SDF1(1) of the first delay time using a predetermined calibration method such as direct subtraction method, that is, SDF(1)=SDF(0)−ED(0), where ED(0) is defined as the delay time difference between the ideal output signal SIDEAL corresponding to the ideal output O-IDEAL and the initial digital-to-analog mixed output MIXD2A(0). And after that, in step 550₂, a second CD2AMM is performed and a first digital-to-analog mixed output MIXD2A(1) is obtained. In step 560₂, the ideal output O-IDEAL obtained in step 530 is compared with the first digital-to-analog mixed output MIXD2A(1), and SDF1(1) is modified to the second calibrated value SDF1(2) of the first delay time using a predetermined calibration method such as direct subtraction method, that is, SDF(2)=SDF(1)−ED(1), or interpolation/extrapolation method, that is, SDF1(2)=SDF1(1)−ED(1)×(SDF1(1)−SDF1(0))/(ED(1)−ED(0)), where ED(1) is defined as the delay time difference between the ideal output signal SIDEAL corresponding to the ideal output O-IDEAL and the first digital-to-analog mixed output MIXD2A(1). Finally, in step 570, the standard delay times of the digital output circuit recoded in the standard delay format DATA-SDF are set according to SDF1(1).

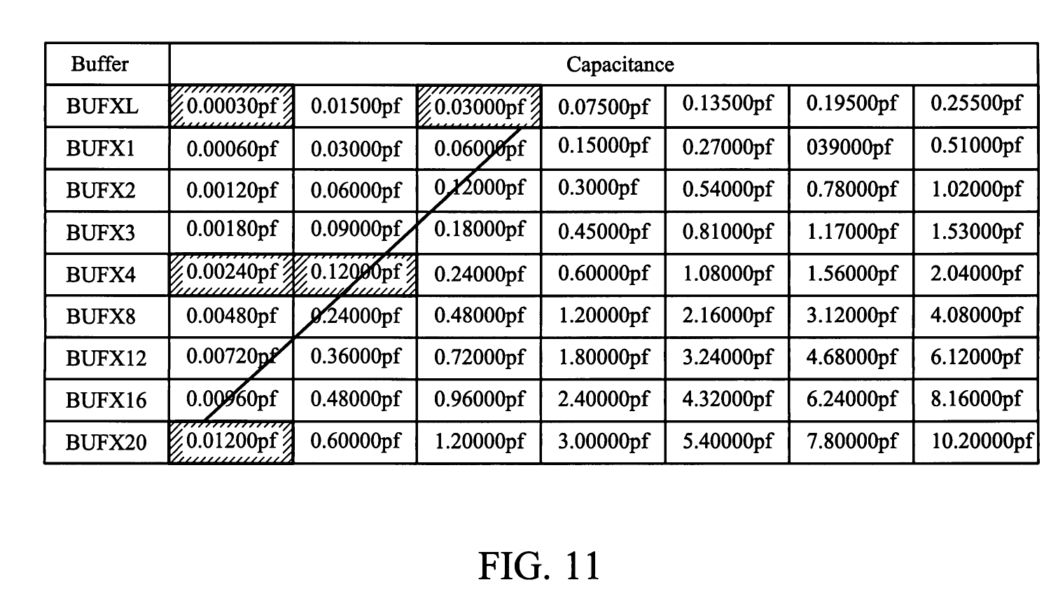

FIG. 11 shows proper range of capacitance of the capacitor 71 corresponding to different buffers 71 in FIGS. 7A-7C using the method shown in FIG. 10. As shown, in the buffer column, BUFX1 to BUFX20 represents driving capacity of different buffers 71. Each of the buffers 71 is simulated together with 7 capacitance value of the capacitor 71. The suitable application range of the invention falls in the left-upward region of the line of the combinations of BUFX1 and capacitance of 0.00030 PF to BUFX20 and capacitance of 0.01200 PF. More specifically, when the buffer is BUFX1, the maximum capacitance value of the capacitor 71 accepted in the invention is 0.00030 PF; when the buffer is BUFX2, the maximum capacitance value of the capacitor 71 accepted in the invention is between 0.0012 PF and 0.0600 PF, and so on. It is noted that, area increase of the digital output circuit and/or analog input circuit expands the suitable application region of the invention.

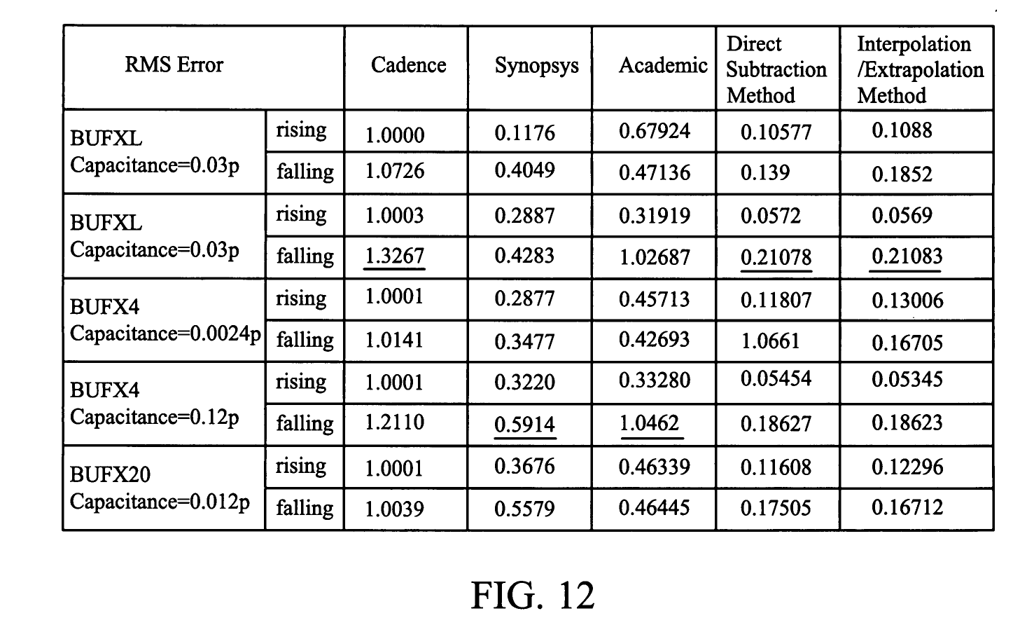

In an example, the digital circuit includes only a buffer and the analog circuit includes only a capacitor. Accordingly, the digital circuit is the digital output circuit and the analog circuit is the analog input circuit as shown in FIG. 11. FIG. 12 shows errors for the delay time T_{MIX} (shown in FIG. 3) of the digital-to-analog mixed signal SMIXA2D obtained by simulations with different mixed-mode simulators and for the delay time T_{MIX1} (shown in FIG. 6) of the digital-to-analog mixed signal SMIXA2D that has been calibrated using the calibration method of the invention, for every corner case of FIG. 11 in such a example, wherein the errors are calculated relative to the delay time T_{IDEAL} (shown in FIG. 6) of the ideal output signal SIDEAL. The formula used in the error calculation is:

RMS(ABS(T_{D}−T_{IDEAL}))/RMS(T_{IEDEAL}),

where TD is T_{MIX} or calibrated T_{MIX1}. In simulations of the figure, default interface elements are used in both CADENCE and SYNOPSYS, and interface element parameters in Acadamic are established by referring to table. As shown, the maximum error in every corner case is respectively 132%, 59%, 104%, and 21% in CADENCE, SYNOPSYS, Acadamic, and the invention.

Since the calibration method for mixed mode simulation decreases extra delay time, accuracy of the mixed mode simulation can be enhanced, thereby preventing false design and increase product yield. Additionally, the invention prevents non-convergence problems often occurring in mixed-mode simulations. Additionally, when a system is separated into digital and analog circuits, increased accuracy of mixed-mode can be achieved no matter how the system is separated. That is, there is improved flexibility in separation of the digital and analog circuits. Additionally, the calibration method of the invention is not restricted by mixed-mode simulation software, and since only a digital output circuit selected from a digital circuit and an analog input circuit selected from an analog circuit are simulated, circuit area can be selected very small with increasing simulation speed accordingly.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A calibration method for a mixed-mode simulation for calibrating standard delay times in a standard delay format, comprising:
selecting a partial circuit at the output end in a digital circuit on which the mixed-mode simulation is to be performed as a digital output circuit;
selecting a partial circuit at the input end in an analog circuit on which the mixed-mode simulation is to be performed as an analog input circuit;
performing a simulation on the digital output circuit connected with the analog input circuit and obtaining an ideal output;
obtaining an initial value of a first delay time according to the standard delay times of the digital circuit in the standard delay format;
performing a calibrative digital-to-analog mixed mode simulation on the digital output circuit and the analog input circuit to obtain a digital-to-analog mixed output using the first delay time at least once;
every time after the calibrative digital-to-analog mixed mode simulation is performed, calibrating the first delay time by comparing the digital-to-analog mixed output with the ideal output, thereby obtaining a final calibrated value of the first delay time; and
calibrating the standard delay times of the digital output circuit in the standard delay format according to the final calibrated value of the first delay time.

2. The method of claim 1, wherein obtaining the initial value of the first delay time comprises obtaining the sum of the original values of the standard delay times of all stages of the digital output circuit in standard delay format as the initial value of the first delay time.

3. The method of claim 1, wherein calibrating the standard delay times of the digital output circuit in the standard delay format according to the final calibrated value of the first delay time comprises portioning the final calibrated value of the first delay time into the standard delay times of all the stages in the digital output circuit using a predetermined setting method.

4. The method of claim 1, wherein calibrating the first delay time by comparing the digital-to-analog mixed output with the ideal output comprises:
obtaining an extra delay time by comparing the digital-to-analog mixed output with the ideal output; and
calibrating the first delay time according to the extra delay time using a predetermined calibration method.

5. The method of claim 1, wherein the calibrative digital-to-analog mixed mode simulation is performed a predetermined number of times.

6. The method of claim 4, wherein the calibrative digital-to-analog mixed mode simulation is performed until the extra delay time is less than a predetermined extra delay time.

7. The method of claim 6, wherein a calibrative digital-to-analog interface element is connected between the digital output circuit and analog input circuit in the calibrative digital-to-analog mixed mode simulation.

8. The method of claim 4, wherein the predetermined calibration method is SDF(1)=SDF1(0)−ED(0) after the calibrative digital-to-analog mixed mode simulation for the first time, where SDF1(1) is the first delay time calibrated after the calibrative digital-to-analog mixed mode simulation of the first time, SDF1(0) is the first delay time used in the calibrative digital-to-analog mixed mode simulation of the first time, and ED1(0) is the extra delay time obtained by the calibrative digital-to-analog mixed mode simulation of the first time.

9. The method of claim 4, wherein the predetermined calibration method is
SDF1(n+1)=SDF1(n)−ED(n)
or
SDF1(n+1)=SDF1(n)−ED(n)×(SDF1(n)−SDF1(n−1))/(ED1(n)−ED(n−1))
after the calibrative digital-to-analog mixed mode simulation is not performed for the first time, where SDF1(n+1) is the calibrated first delay time after the current calibrative digital-to-analog mixed mode simulation, SDF1(n) is the first delay time used in the current calibrative digital-to-analog mixed mode simulation, SDF1(n−1) is the first delay time used in the previous calibrative digital-to-analog mixed mode simulation, ED1(n) is the extra delay time obtained by the current calibrative digital-to-analog mixed mode simulation, and ED1(n−1) is the extra delay time obtained by the previous calibrative digital-to-analog mixed mode simulation.

10. The method of claim 5, wherein the predetermined times are two times.

11. The method of claim 1, wherein performing a simulation on the digital output circuit connected with the analog input circuit and obtaining an ideal output is realized with transistor-level simulation software.

12. The method of claim 7, wherein the calibrative digital-to-analog interface element comprises:
a selecting switch having first to fourth terminals, wherein the third and fourth terminals respectively act as output and input terminals of the calibrative digital-to-analog interface element, and voltage at the third terminal controls the fourth terminal to output voltage at the first or second terminal;
a first resistor connected between a voltage source and the first terminal;
a second resistor connected between a reference voltage and the second terminal;
a first capacitor connected between the reference voltage and the first terminal; and
a second capacitor connected between the reference voltage and the second terminal.

13. The method of claim 7, wherein the calibrative digital-to-analog interface element is a digital-to-analog interface element of a mixed-mode simulator used in the mixed-mode simulation.

14. The method of claim 1, wherein the digital output circuit is logic components of the last stage in the digital circuit.

15. The method of claim 1, wherein the analog input circuit is input capacitor of the analog circuit.
